(19) United States
(12) Patent Application Publication
(10) Pub. No.: US 2006/0265333 A1
(43) Pub. Date: Nov. 23, 2006

(54) Mesh network with digital rights management interoperability

(75) Inventors: Sylvie Gomes, Douglaston, NY (US); Alan Gerald Carlton, Mineola, NY (US); Alain Charles Louis Briancon, Poolesville, MD (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/415,235

(22) Filed: May 1, 2006

Related U.S. Application Data
(60) Provisional application No. 60/677,279, filed on May 3, 2005.

(51) Int. Cl. G06Q 99/00

(52) U.S. Cl. 705/57

(57) ABSTRACT

A wireless mesh network with digital rights management (DRM) interoperability is disclosed. A first DRM-capable mesh point (MP) performs a discovery procedure for detecting neighbor MPs and identifies at least one other DRM-capable MP among the detected neighbor MPs. The first DRM-capable MP then performs an association procedure only with the DRM-capable MPs. The first DRM-capable MP assigns DRM roles to the associated DRM-capable MPs. A digital content is then distributed from the first DRM-capable MP to another DRM-capable MP via the mesh network. The DRM interoperability may be based on a networked environment for media orchestration (NEMO) architecture proposed by the Coral Consortium or any DRM interoperability architectures.

### CROSS REFERENCE TO RELATED APPLICATION

This application claims the benefit of U.S. Provisional Application No. 60/677,279 filed May 3, 2005, which is incorporated by reference as if fully set forth.

### FIELD OF INVENTION

The present invention is related to digital rights management (DRM) systems. More particularly, the present invention is related to a wireless mesh network with DRM interoperability.

### BACKGROUND

Mesh networks are self-configuring systems including a plurality of nodes, (i.e., mesh points (MPs)). Each node can relay messages on behalf of others. Mesh networks have advantages of enhanced range of coverage and available bandwidth. Although mesh networks are already in use in military type deployments and in some industry sectors, none of the conventional mesh network systems interoperate or are suitable for a domestic or office environment. The IEEE 802.11s standard is currently being developed for using mesh networks of small to medium sizes up to 32 nodes for a domestic and office environment. The IEEE 802.11s standard will allow for diverse applications and future innovations.

DRM is a technology used to enforce pre-defined policies controlling access to digital content, such as software, music, movies, documents, or the like. DRM systems allow content providers to sell their content to end users in a relatively secure manner. However, current DRM systems work only in closed systems so that different DRM systems are not interoperable. With a certain DRM system, end users may have access to the purchased content only with devices that support that certain DRM system. As a result, consumers are forced to purchase different versions of the same content to access the content with other devices.

There are standards that are currently being investigated with the goal of making existing DRM systems interoperable. For example, the Coral Consortium is working towards defining a standard for interoperability of DRM systems and has released specifications describing a networked environment for media orchestration (NEMO) using a service-oriented approach.

Conventional mesh network systems are limited in establishing a mesh network providing DRM interoperability because the MPs associate to each other based only on basic MP criteria, (such as operating channels and frequencies, signal strength, MP capabilities, quality of services (QoS), MP link state, or the like), and not based on higher layer MP functionalities, such as DRM capabilities. Another problem with conventional NEMO systems is that the MPs are already connected to each other through the network (wired or wireless) before executing security functions, (e.g., identification, authentication, or the like).

### SUMMARY

The present invention is related to a wireless mesh network with DRM interoperability. In accordance with the present invention, DRM-capable MPs associate only with DRM-capable MPs. A first DRM-capable MP performs a discovery procedure to detect neighbor MPs and identifies at least one other DRM-capable MP among the detected neighbor MPs. The first DRM-capable MP then associates only with the at least one other DRM-capable MP and performs an authentication procedure. The first DRM-capable MP assigns DRM roles to the at least one other associated DRM-capable MP. A digital content is then distributed from the first DRM-capable MP to the at least one other associated DRM-capable MP via the mesh network. The DRM interoperability may be based on a NEMO architecture proposed by the Coral Consortium or any DRM interoperability architectures.

### BRIEF DESCRIPTION OF THE DRAWINGS

A more detailed understanding of the invention may be illustrated from the following description of a preferred embodiment, given by way of example and to be understood in conjunction with the accompanying drawing wherein:

FIG. 1 is a flow diagram of a process for DRM interoperability in a mesh network in accordance with the present invention;

FIG. 2 is a block diagram of a mesh point in accordance with the present invention;

FIG. 3 is a block diagram of a protocol stack of a NEMO device for performing security functions in accordance with the present invention;

FIG. 4 is a diagram of a mesh capability information element (IE) in accordance with the present invention; and

FIG. 5 is an exemplary bitmap for the optional capabilities supported field of the mesh capability IE in accordance with the present invention.

### DETAILED DESCRIPTION OF THE PREFERRED EMBODIMENTS

Hereafter, the terminology “MP” includes but is not limited to a wireless transmit/receive unit (WTRU), a user equipment (UE), a mobile station, a fixed or mobile subscriber unit, a pager, a Node-B, a base station, a site controller, an access point (AP), or any other type of device capable of operating in a mesh wireless environment.

The features of the present invention may be incorporated into an integrated circuit (IC) or be configured in a circuit comprising a multitude of interconnecting components.

Hereafter, the present invention will be described with reference to Coral Consortium and a NEMO DRM interoperability architecture. However, it should be noted that the present invention may be applied to any DRM interoperability architectures.

The present invention provides a method for building a mesh network providing DRM interoperability. In establishing such a mesh network, it is not efficient for non-DRM-capable MPs to be involved at the same level as DRM-capable MPs which have more pertinent content related functionalities. Therefore, in accordance with the present invention, DRM-capable MPs associate only with DRM-capable MPs. This is achieved by updating a local MP neighbor list in each MP based not only on basic MP capabilities, but also on higher layer MP functionality such as the DRM capabilities of the MPs.

In accordance with the present invention, during association, MPs exchange information regarding capabilities of the MPs including higher layer MP functionality such as the DRM capabilities. The DRM capabilities may only indicate that the device is DRM-capable, (i.e., has DRM functionalities), or may include more detailed DRM capability information, such as audio capabilities, video capabilities, resolution, computational capabilities, encryption capabilities, secure lock, or the like.

Preferably, MPs associate only with other MPs that have been identified and authenticated before the wireless network is built. This is achieved by performing some security functions, such as identification and authentication at the MAC layer, which is performed, for example, in IEEE 802.11a mesh networks. In another example, IEEE 802.1 μl-based security procedures may be implemented using IEEE 802.1x authentication and key management, (e.g., for large office or campus), or Pre-Shared Key (PSK), (e.g., for small office or home), or the like. The authentication procedure may use extensible authentication protocol (EAP) or EAP over LAN (EAPOL). It should be noted that the procedures and standards as described hereinbefore are exemplary, and the present invention is not limited only to such implementations.

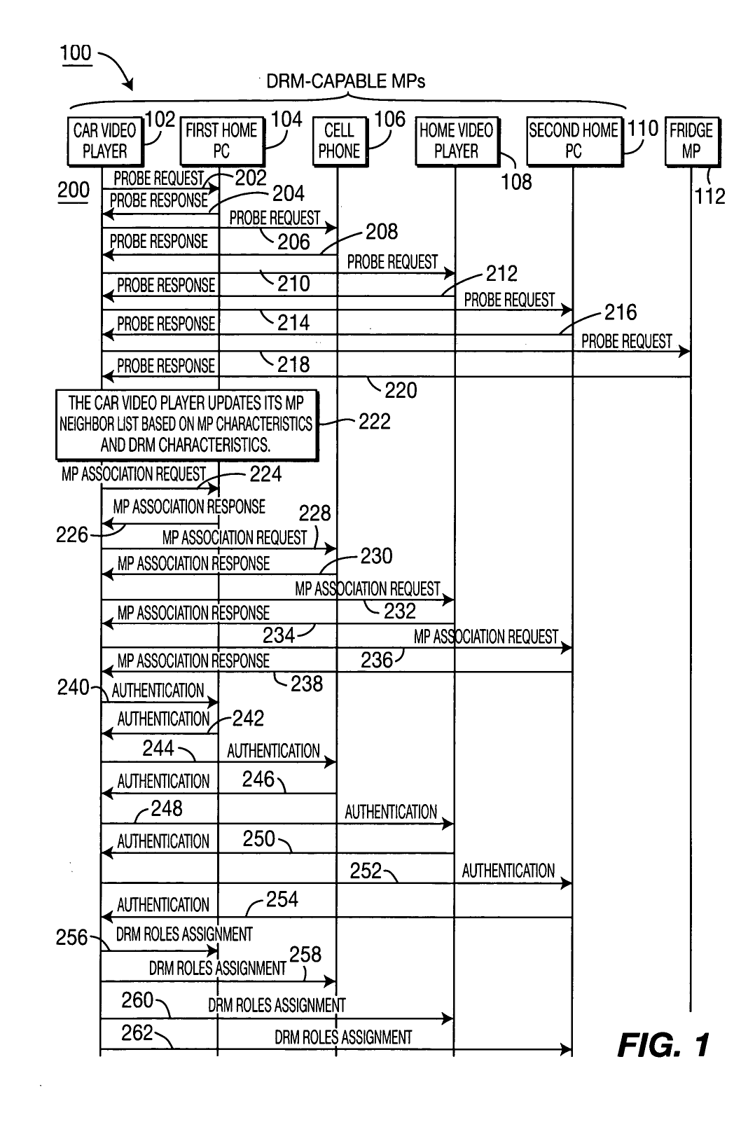

FIG. 1 is a flow diagram of an exemplary process 200 for DRM interoperability in a mesh network 100 including a plurality of MPs in accordance with the present invention. In this example, a user has a plurality of mesh-enabled devices, such as a car video player 102, a first home PC 104, a cellular phone 106, a home video player 108, a second home PC 110 and a refrigerator MP 112. These devices 102, 104, 106, 108, 110 and 112 are mesh-enabled devices and therefore may work as an MP in a mesh network. Hereafter, each of the devices 102, 104, 106, 108, 110 and 112 will be referred to as an MP interchangeably. The devices 102, 104, 106, 108 and 110 are DRM-capable, while the refrigerator MP 112 is not. Each of these DRM-capable devices 102, 104, 106, 108 and 110 may support different DRM systems.

Let's assume that the user has acquired new digital content that can be played in the car video player 102. The user arrives at home and wants to transfer the digital content to other devices, (e.g., to the home video player 108), to play the new digital content at home. The transfer of the digital content is initiated when the user arrives at home and turns on the car video player 102.

The car video player 102 starts a discovery process by scanning through the radio channels and locates neighbor MPs 104, 106, 108, 110 and 112. The discovery process may be performed by detecting beacon frames transmitted by other MPs 104, 106, 108, 110 and 112. Alternatively, the discovery process may be performed by exchanging probe request frames and probe response frames with other MPs 104, 106, 108, 110 and 112, as is illustrated in FIG. 1. The car video player 102 sends a probe request frame 202 to the first home PC 104, a probe request frame 206 to the cell phone 106, a probe request frame 210 to the home video player 108, a probe request frame 214 to the second home PC 110 and a probe request frame 218 to the refrigerator MP 112. The car video player 102 receives probe response frames 204, 208, 212, 216 and 220 from the MPs 104, 106, 108, 110 and 112, respectively. The car video player 102 then updates and stores its local MP neighbor list based on the MP characteristics and DRM characteristics received via the probe response frames (step 222). The car video player 102 includes in its neighbors MP list the MPs 104, 106, 108 and 110 which indicate the DRM capabilities in probe response frames 204, 208, 212 and 216 and excludes the MP 112 which does not advertise DRM capabilities in its probe response frame 220.

Once the car video player 102 updates its MP neighbor list, the car video player 102 initiates an association with the DRM-capable MPs 104, 106, 108 and 110 in the MP neighbor list by sending an MP association request 224 to the first home PC 104, an MP association request 228 to the cellular phone 106, an MP association request 232 to the home video player 108 and an MP association request 236 to the second home PC 110, respectively. The car video player 102 receives MP association responses 226, 230, 234 and 238 from the MPs 104, 106, 108 and 110, respectively. In order to complete the association procedure, the car video player 102 and the DRM-capable MPs 104, 106, 108 and 110 perform authentication procedures, preferably based on IEEE 802.11i-based security procedures, by exchanging authentication messages 240 and 242 with the first home PC 104, authentication messages 244 and 246 with the cell phone 106, authentication messages 248 and 250 with the home video player 108, and authentication messages 252 and 254 with the second home PC 110.

Upon successful authentication, the car video player 102 starts assigning DRM roles to its associated DRM-capable MPs 104, 106, 108 and 110 based on their capabilities via DRM roles assignment messages 256, 258, 260 and 262. These roles are defined in the Functional Architecture of the Coral Consortium specifications.

For example, the car video player 102 takes roles of a license source and a content exporter. The first home PC 104 may take roles of a rights mediator, a client, a content mediator and a content ID provider. The cellular phone 106 and the home video player 108 may take roles of a license issuer and a content importer. The second home PC 110 may take the role of a content transformer.

The car video player 102, as a license source, provides information about the rights pertaining to the digital video content to the first home PC 104, which works as a rights mediator and collects information required to apply a set of policies to make a decision on what device may access the digital video content and registers the result of the decision with the source (device providing the content) and the destinations (device receiving the content).

The car video player 102, as a content exporter, then exports, (i.e., transmits wirelessly), the digital video content to another device, (i.e., MP), belonging to the wireless mesh network 100. Assuming that the receiving device is the home video player 108, the home video player 108 acting as a license issuer then transforms the abstract rights into licenses for the different DRM systems in the wireless mesh network 100, after having verified with the first home PC 104 (which is a rights mediator) that the other devices are allowed to access the content.

The home video player 108, as a content importer, then packages the digital video content using the designated import mechanism of the DRM system to which it is attached. Once the content is repackaged and the rights are translated, the digital video content may be accessed on any device with video capabilities in the wireless mesh network 100 by using the first home PC 104 as a content mediator since the content mediator is responsible for coordinating the activities of the content exporter (the car video player 102), the content importer (home video player 108) and the content transformer (second home PC 110) that are necessary for passing the content instance from one device to another.

If the car video player 102 leaves the mesh network 100, the assigned roles may be reassigned between the remaining DRM devices 104, 106, 108 and 110. For example, the home video player 108 may distribute the content to a new DRM node joining the home mesh network 100.

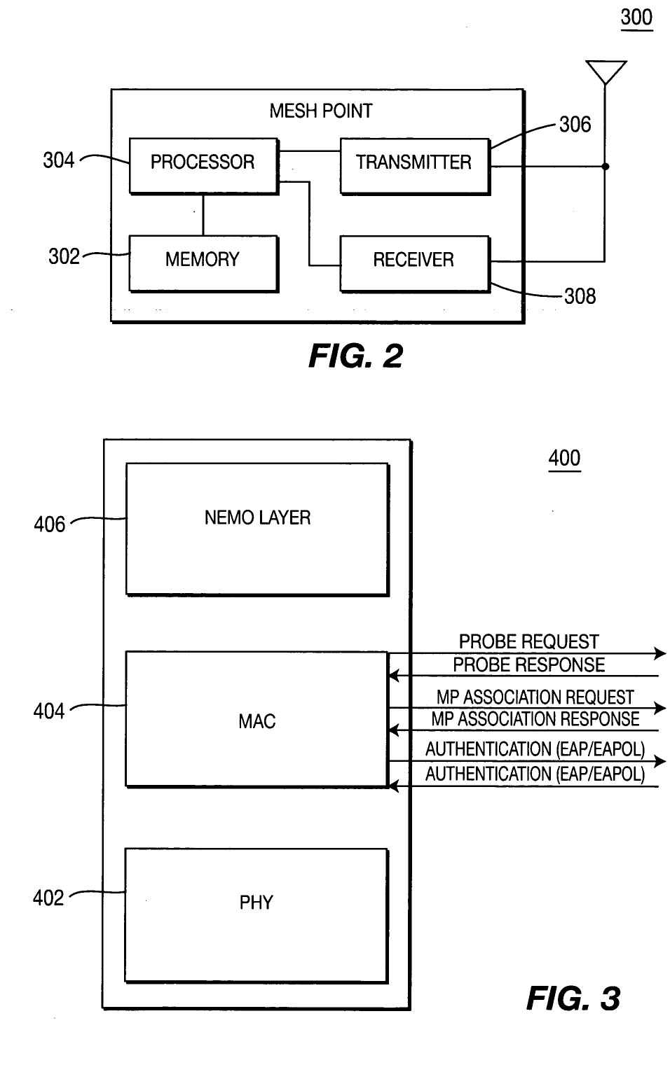

As shown in FIG. 2, each of the MPs 102, 104, 106, 108, 110 and 112 may include a memory 302 to store the MP neighbor list, a processor 304, a transmitter 306 and a receiver 308. The processor 304 controls transmission and reception of data, (such as probe request frames and probe response frames), via the transmitter 306 and the receiver 308, respectively, and updates the MP neighbor list in the memory 302 as neighbor MPs are detected via the probe response frames, (or beacon frames).

The MP characteristics include, but are not limited to, MP identity (ID), current channel and frequency, signal strength, MP capabilities, or the like. The DRM characteristics include, but are not limited to, a NEMO node ID and NEMO node DRM capabilities.

Every NEMO node is identified by at least one unique ID. This ID may be built-in initially, or it may be acquired by a personalization service after deployment, (e.g., by proving possession of a bootstrap secret). The MP ID is used as a unique ID. With respect to the NEMO node DRM capabilities, the car video player 102 includes in its MP neighbor list only DRM-capable MPs, (such as MPs 104, 106, 108 and 110), and not MPs that have no DRM capabilities, (such as the MP 112).

In accordance with the present invention, security functions like node identification and authentication are performed at a medium access control (MAC) layer. FIG. 3 is a block diagram of a protocol stack of a NEMO device 400, (i.e., a DRM-capable device such as devices 102, 104, 106, 108 and 110 in FIG. 1), for performing security functions in accordance with the present invention. The device 400 includes a physical layer (PHY) 402, a MAC layer 404 and higher layers including a NEMO layer 406. Security functions, such as MP identification, MP capability exchange and MP authentication are performed in the MAC layer 404 using probe request/response frames, MP authentication request/response frames and extensible authentication protocol (EAP)/EAP over LAN (EAPOL) authentication messages.

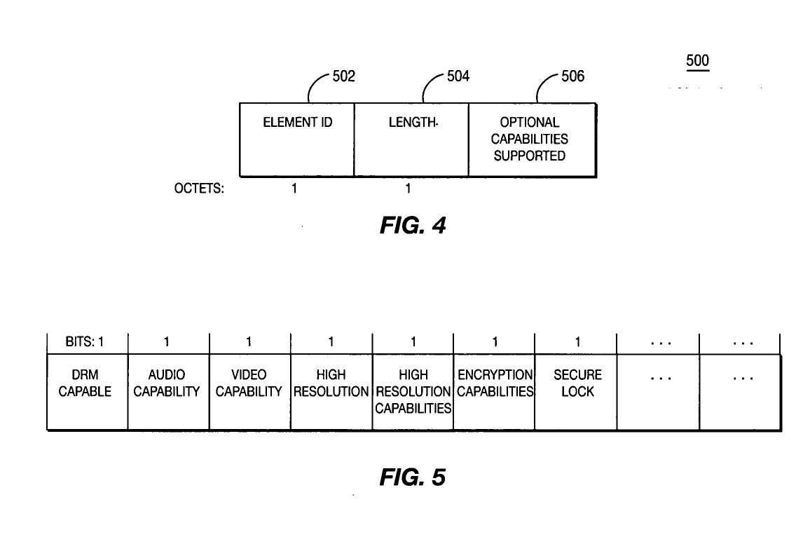

For speeding up the discovery process, the mesh capability IE in the beacon frame, the probe response frame, or other frame, (such as an association request frame or an association response frame), may include DRM capabilities of the MPs. Referring to FIG. 4, a diagram of a mesh capability IE 500 in accordance with the present invention is shown. The mesh capability IE 500 includes an element ID field 502, a length field 504 and an optional capabilities supported field 506. The element ID 502 identifies the mesh capability IE. The length field 504 indicates the length of the optional capabilities supported field 506. A bitmap of the optional capabilities supported field 506 indicates supported capabilities of the MP. The MP sets corresponding bits in the bitmap to indicate which additional capabilities are supported by the MP.

FIG. 5 is an exemplary bitmap for the optional capabilities supported field 506. It should be recognized that this particular bitmap is by way of example only, and other configurations may be utilized in accordance with the present invention. However, in accordance with the present invention, MP DRM capabilities are included in the optional capabilities supported field 506 as shown in FIG. 5.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A method for establishing a mesh network having digital rights management (DRM) interoperability, the mesh network including at least two DRM-capable mesh points (MPs), the method comprising:
(a) a first of the DRM-capable MPs performing a discovery procedure for detecting neighbor MPs;
(b) the first DRM-capable MP identifying at least one other DRM-capable MP among the detected neighbor MPs;
(c) the first DRM-capable MP performing an association procedure with at least one other DRM-capable MP identified in step (b);
(d) the first DRM-capable MP and the at least one associated DRM-capable MP performing an authentication procedure; and
(e) the first DRM-capable MP assigning DRM roles to the at least one associated MP such that digital content may be distributed from the first DRM-capable MP to the at least one associated DRM-capable MP.

2. The method of claim 1 wherein each of a plurality of neighbor MPs provide DRM characteristic information to the first DRM-capable MP during the discovery process, whereby the first DRM-capable MP detects the at least one other DRM-capable MP based on the DRM characteristic information.

3. The method of claim 2 wherein the DRM characteristic information indicates that the at least one other DRM-capable MP has DRM functionality.

4. The method of claim 2 wherein the DRM characteristic information includes at least one of audio capabilities, video capabilities, resolution, computational capabilities, encryption capabilities and secure lock of the at least one other DRM-capable MP.

5. The method of claim 1 wherein step (a) is performed by detecting beacon frames transmitted by neighbor MPs.

6. The method of claim 1 wherein the discovery process is performed by exchanging probe request frames and probe response frames with neighbor MPs.

7. The method of claim 1 wherein the DRM interoperability is achieved based on a networked environment for media orchestration (NEMO) architecture proposed by Coral Consortium.

8. The method of claim 2 wherein the DRM characteristic information includes a device identity (ID).

9. The method of claim 8 wherein the device ID is unique to each of the MPs.

10. The method of claim 8 wherein the device ID is provided initially to each of the MPs.

11. The method of claim 8 wherein the device ID is provided by a personalization service after deployment of the mesh network.

12. The method of claim 11 wherein the device ID is provided by proving possession of a bootstrap secret.

13. The method of claim 1 wherein the first DRM-capable MP performs the authentication procedure based on IEEE 802.11i-based security procedures.

14. The method of claim 1 wherein the first DRM-capable MP performs the discovery procedure, the association procedure and the authentication procedure at a medium access control (MAC) layer.

15. The method of claim 1 further comprising:
reassigning DRM roles when one of the MPs leaves the mesh network.

16. A mesh network having digital rights management (DRM) interoperability, the mesh network comprising:
a plurality of DRM-capable mesh points (MPs), each of the DRM-capable MPs comprising:
a memory for storing an MP neighbor list; and
a processor coupled to the memory, the processor configured to perform a discovery procedure to detect neighbor MPs, identify at least one other DRM-capable MP among the detected neighbor MPs, update the MP neighbor list with the at least one other DRM-capable MP, perform an association procedure with the at least one other DRM-capable MP, perform an authentication procedure with the at least one associated DRM-capable MP, and assign DRM roles to the at least one associated DRM-capable MP such that digital content may be distributed to the at least one associated DRM-capable MP.

17. The mesh network of claim 16 wherein the processor is configured to receive DRM characteristic information provided by neighbor MPs during the discovery procedure, whereby the procedure detects the at least one other DRM-capable MP based on the DRM characteristic information.

18. The mesh network of claim 17 wherein the DRM characteristic information indicates that the at least one other DRM-capable MP has DRM functionality.

19. The mesh network of claim 17 wherein the DRM characteristic information includes at least one of audio capabilities, video capabilities, resolution, computational capabilities, encryption capabilities and secure lock.

20. The mesh network of claim 16 wherein the processor is configured to detect beacon frames transmitted by neighbor MPs whereby the processor detects the at least one other DRM-capable MP based on the beacon frames.

21. The mesh network of claim 16 wherein the processor is configured to exchange probe request frames and probe response frames with neighbor MPs in order to detect the neighbor MPs.

22. The mesh network of claim 16 wherein the DRM interoperability is achieved based on a networked environment for media orchestration (NEMO) architecture proposed by Coral Consortium.

23. The mesh network of claim 17 wherein the DRM characteristic information includes a device identity (ID).

24. The mesh network of claim 23 wherein the device ID is unique to each of the MPs.

25. The mesh network of claim 23 wherein the device ID is provided initially to each of the MPs.

26. The mesh network of claim 23 wherein the device ID is provided by a personalization service after deployment of the mesh network.

27. The mesh network of claim 26 wherein the device ID is provided by proving possession of a bootstrap secret.

28. The mesh network of claim 16 wherein the processor is configured to perform an authentication procedure based on IEEE 802.11i-based security procedures.

29. The mesh network of claim 16 wherein the processor is configured to perform the discovery procedure, the association procedure and the authentication procedure at a medium access control (MAC) layer.

30. The mesh network of claim 16 wherein the processor configured to reassign DRM roles when one of the MPs leaves the mesh network.

31. A mesh point (MP) in a mesh network having digital rights management (DRM) interoperability, the MP comprising:
a memory for storing an MP neighbor list; and
a processor coupled to the memory, the processor configured to perform a discovery procedure to detect neighbor MPs, identify at least one other DRM-capable MP among the detected neighbor MPs, update the MP neighbor list with the at least one other DRM-capable MP, perform an association procedure with the at least one other DRM-capable MP, perform an authentication procedure with the at least one associated DRM-capable MP, and assign DRM roles to the at least one associated DRM-capable MP such that digital content may be distributed to the at least one associated DRM-capable MP.

32. The MP of claim 31 wherein the processor is configured to receive DRM characteristic information provided by neighbor MPs during the discovery procedure, whereby the procedure detects the at least one other DRM-capable MP based on the DRM characteristic information.

33. The MP of claim 32 wherein the DRM characteristic information indicates that the at least one other DRM-capable MP has DRM functionality.

34. The MP of claim 32 wherein the DRM characteristic information includes at least one of audio capabilities, video capabilities, resolution, computational capabilities, encryption capabilities and secure lock.

35. The MP of claim 31 wherein the processor is configured to detect beacon frames transmitted by neighbor MPs whereby the processor detects the at least one other DRM-capable MP based on the beacon frames.

36. The MP of claim 31 wherein the processor is configured to exchange probe request frames and probe response frames with neighbor MPs in order to detect the neighbor MPs.

37. The MP of claim 31 wherein the DRM interoperability is achieved based on a networked environment for media orchestration (NEMO) architecture proposed by Coral Consortium.

38. The MP of claim 32 wherein the DRM characteristic information includes a device identity (ID).

39. The MP of claim 38 wherein the device ID is unique to each of the MPs.

40. The MP of claim 38 wherein the device ID is provided initially to each of the MPs.

41. The MP of claim 38 wherein the device ID is provided by a personalization service after deployment of the mesh network.

42. The MP of claim 31 wherein the device ID is provided by proving possession of a bootstrap secret.

43. The MP of claim 31 wherein the processor is configured to perform an authentication procedure based on IEEE 802.11i-based security procedures.

44. The MP of claim 31 wherein the processor is configured to perform the discovery procedure, the association procedure and the authentication procedure at a medium access control (MAC) layer.

45. The MP of claim 31 wherein the processor configured to reassign DRM roles when one of the MPs leaves the mesh network.

46. An integrated circuit (IC) embedded in a mesh point (MP) in a mesh network having digital rights management (DRM) interoperability, the IC comprising:
a memory for storing an MP neighbor list; and
a processor coupled to the memory, the processor configured to perform a discovery procedure to detect neighbor MPs, identify at least one other DRM-capable MP among the detected neighbor MPs, update the MP neighbor list with the at least one other DRM-capable MP, perform an association procedure with the at least one other DRM-capable MP, perform an authentication procedure with the at least one associated DRM-capable MP, and assign DRM roles to the at least one associated DRM-capable MP such that digital content may be distributed to the at least one associated DRM-capable MP.
